(19) United States
(12) Patent Application Publication
(10) Pub. No.: US 2008/0036601 A1
(43) Pub. Date: Feb. 14, 2008

(54) RADIO FREQUENCY INTEGRATION PLATFORM AND NETWORK THEREFOR

(76) Inventors: Louis H. THOMPSON, Mt. Vernon, GA (US); Ray Hamilton, Vidalia, GA (US); Les Thompson, Stockbridge, GA (US); Sheree Hagan, Vidalia, GA (US)

Correspondence Address: Ralph A. Dowell of DOWELL & DOWELL P.C., 2111 Eisenhower Ave, Suite 406, Alexandria, VA, 22314, US

(21) Appl. No.: 11/837,382

(22) Filed: Aug. 10, 2007

Related U.S. Application Data
(60) Provisional application No. 60/836,956, filed on Aug. 11, 2006.

(51) Int. Cl. G08B 13/14

(52) U.S. Cl. 340/572.1

(57) ABSTRACT

A system for monitoring a radio frequency identification (RFID) network, including a plurality of radio frequency (RF) antennas that transmit signals representative antenna data, an RF switch for isolating a signal from an antenna, a RF switch controller for controlling the RF switch, and a reader for reading the signals from the antennas, wherein the system only requires one reader to monitor the RFID network. A radio frequency integration platform (RFIP) monitors a plurality of RFID networks. The RFIP includes an RFIP server and an RFIP database for managing antenna and RFID network data.

### CROSS-REFERENCE TO RELATED APPLICATIONS

This application claims priority to U.S. provisional patent application No. 60/836,956 to Thompson et al., entitled “Radio Frequency Integration Platform and Network Therefor” and filed on Aug. 11, 2006, which is hereby incorporated by reference in its entirety.

### BACKGROUND OF THE INVENTION

1. Field of the Invention

This invention is generally directed to a radio frequency integration platform (RFIP) hardware device for monitoring a wide spread radio frequency identification (RFID) network, wherein the RFIP hardware device employs only one RFID tag reader. The invention is also generally directed to an RFIP framework for managing several RFIP monitored RFID networks.

2. Discussion of Related Art

Radio frequency identification systems are well known for object and personnel tracking, surveillance, inventory control, and the like, wherein either active or passive RFID tags are placed on objects or personnel to be monitored. Each tag is provided with a unique code which is communicated via a signal. If the tag is passive, then the tag is activated upon the receipt of radio frequency (RF) energy. When the passive tag is activated, it then sends a signal indicative of the unique signature for the tag to a detector. In an active tag system, the tag also carries unique information which is transmitted in a signal. However, unlike a passive tag, the information is periodically broadcast to a detector or sensor mounted in a remote location through energy supplied by a battery associated with the active tag. The timing of the lumination of energy from the tag can be built into the tags during their manufacture. In some RFID systems, tags can be used having both active and passive characteristics.

RFID systems which are currently in use generally operate either using omnidirectional transceivers, for passive tag systems, or receivers, for active tag systems. The omnidirectional nature of the transceivers or receivers is predicated upon the configuration of the antennas which are used for broadcasting or receiving radio frequency signals.

Generally, each tag of a passive or an active system is designed to operate at a generally specific frequency, which may be chosen to suit a particular environment. That is, the frequency is chosen so as not to interfere with other radio frequency equipment which may be located within a facility or in the environment of the RFID tag system. Currently, systems are designed which operate both at high frequency wavelengths, as well as relatively low frequency wavelengths.

With conventional systems utilizing the omnidirectional antenna transceivers or receivers, it has generally been the practice to utilize transceivers or receiving antennas which are electrically connected to control readers or the like. These RFID networks must be installed so that there is one reader for each antenna. Thus, such a conventional RFID network generally requires the use of many control readers. Further, the use of multiple readers often requires the use of additional hardware and software to network all the readers and sort data detected by each reader.

In view of the foregoing, there is a need for a cost-effective integration system that is able to monitor a widespread RFID network without using multiple readers or the additional hardware, such as network drops and power drops, and software associated therewith. Subsequently, there also exists a need for a framework for managing multiple integrations systems.

### SUMMARY

The present invention is directed to a system for monitoring a radio frequency identification (RFID) network. The system includes a plurality of radio frequency (RF) antennas that transmit signals representative antenna data, an RF switch for isolating a signal from an antenna, a RF switch controller for controlling the RF switch, and a reader for reading the signals from the antennas. The system only requires one reader to monitor the RFID network so that the system can manage a widespread RFID network without the need for multiple readers.

The present invention further involves a radio frequency integration platform (RFIP) that monitors a plurality of RFID networks. The RFIP includes an RFIP server and an RFIP database for managing antenna and RFID network data. The RFIP framework is scalable and extensible so that additional components can be easily added to the RFIP.

### BRIEF DESCRIPTION OF THE DRAWINGS

A better understanding of the invention will be had with respect to the accompanying drawings wherein:

FIGS. 1a and 1b are a top plan views of a radio frequency integration platform (RFIP) hardware device of the present invention;

FIG. 2 is a rear perspective view of the RFIP hardware device, where the RFIP has a hard wired connection;

FIG. 3 is a rear perspective view of the RFIP hardware device, where the RFIP has a wireless connection;

FIG. 4 is an illustrational view of a basic configuration network for managing a plurality of RFIP hardware devices; and

FIG. 5 is an illustrational view of a remote configuration network for managing a plurality of RFIP hardware devices.

### DESCRIPTION OF THE PREFERRED EMBODIMENTS

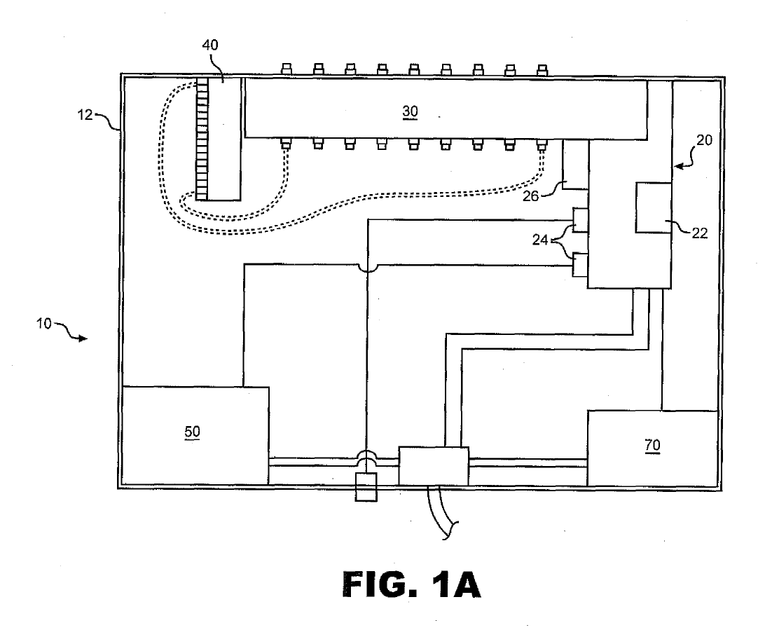

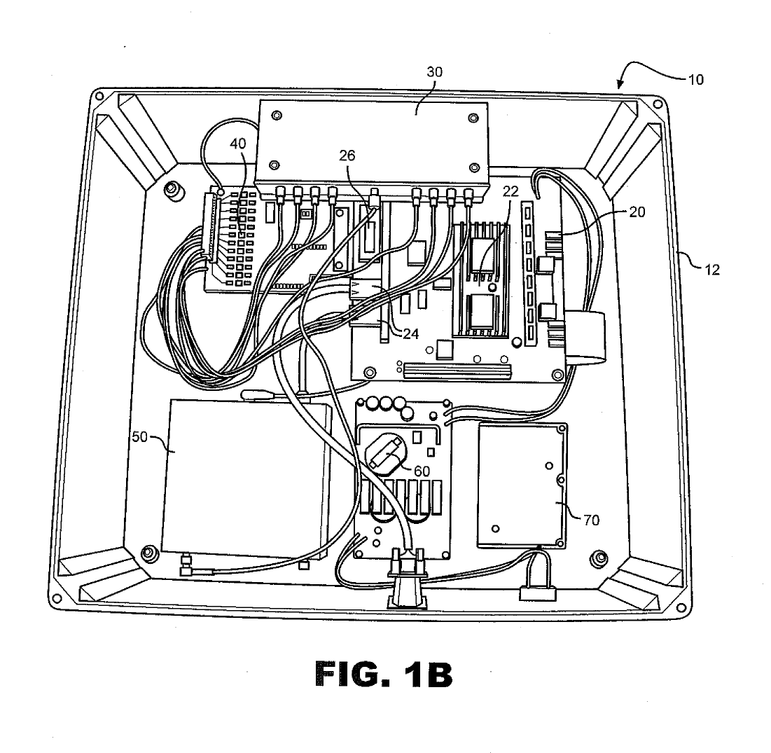

As previously described, the present invention is directed to a radio frequency integration platform (RFIP) hardware device for monitoring a widespread radio frequency identification (RFID) network, wherein the RFIP utilizes only one RFID tag reader. As shown in FIG. 1, an RFIP hardware device 10 includes a housing 12, in which is mounted a motherboard 20. The motherboard 20 includes a central processing unit (CPU) 22, two network adaptors 24, and a parallel port 26.

The RFIP hardware device 10 also includes an RF switch 30 and an RF switch controller 40. The RF switch controller 40 provides input to the RF switch 30 to isolate an RF signal from a particular antenna of an RFID tag for a required read time.

The RFIP hardware device 10 further comprises an RFID reader 50, a power supply 60, and data storage device 70. The RFID reader 50 interprets RF signals received from antennas of RFID tags and converts the signals into RFID tag beacon data. The power supply 60 provides clean power to the system.

To link all of the components of the RFIP hardware device 10 with the motherboard 20, one of the network adaptors 24 is connected to the reader 50, and the other of the network adaptors 24 is connected to an outside network. Further, the parallel port 26 of the motherboard 20 interfaces with the RF switch controller 40, which interacts, as stated above, with the REF switch 30.

In use, the RFIP hardware device 10 is driven by software employing a real time “time sliced” methodology that allows the RFID reader 50 to receive signals from each of the antennas of the RFID tags for a specific amount of time and/or monitor them simultaneously. Since the RFIP hardware device 10 is software driven, antenna scanning algorithms can be developed to intelligently monitor each antenna of the RFID tags. Accordingly, the RFIP system is useful when antennas are not required to be continuously monitored.

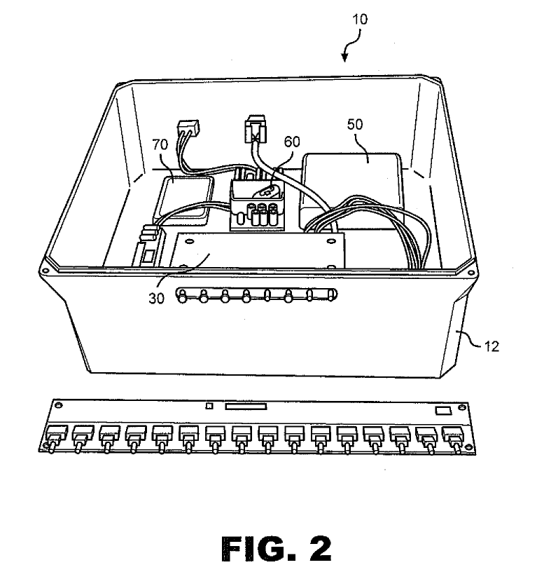

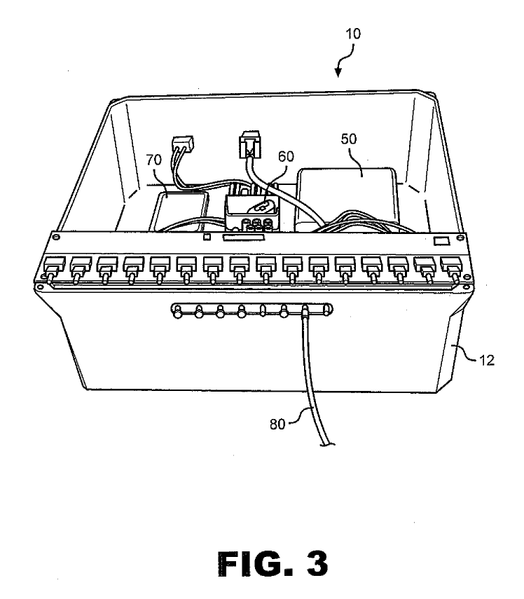

The antenna data is then processed by the CPU 22 and stored in the data storage device 70. The data is only released to an outside network when a specific event occurs or when a user queries the data so that the system is not overloaded with duplicate information. Further, the RFIP hardware device 10 can have a wireless connection to the antenna or to the outside network, as shown in FIG. 2, or be hardwired to the antenna or to the outside network via cable 80, as shown in FIG. 3, to mitigate against security issues, data traffic issues, and the like.

In addition to providing an RFIP hardware device, the present invention also provides for an RFIP framework for managing several RFIP-monitored RFID networks. When an enterprise has multiple buildings in different cities or on opposite sides of the globe, the RFIP framework can be configured as a global framework.

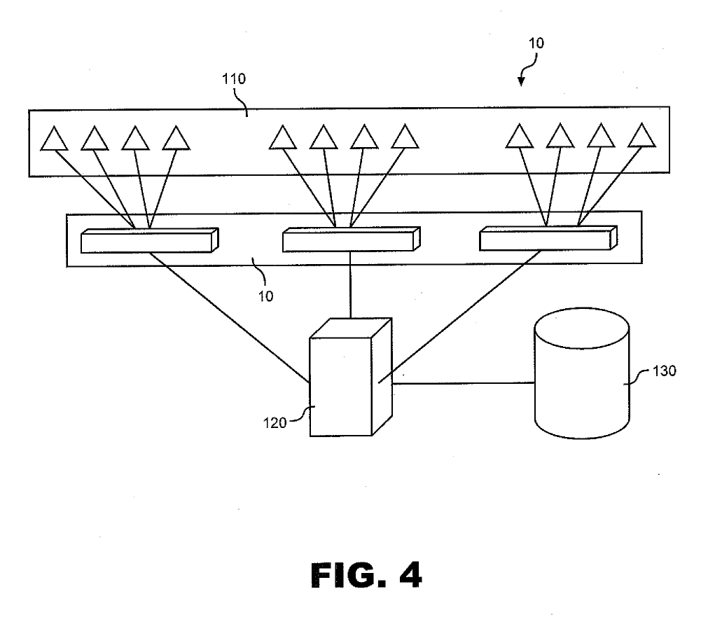

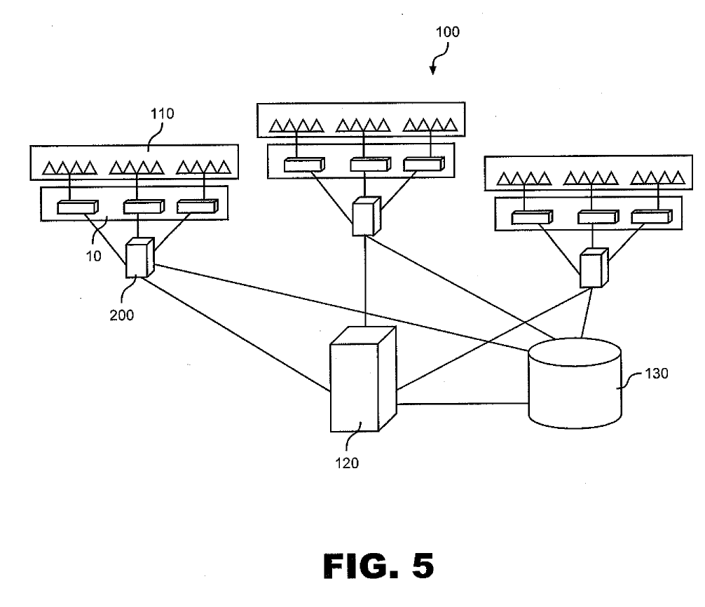

As illustrated in FIGS. 4 and 5, an RFIP framework 100 generally comprises antennas 110 of RFID tags, at least one RFIP hardware device 10, as described above, a RFIP device server 120, and an RFIP database 130. As the number of RFID tags and antennas 110, and subsequently the size of the enterprise increases, the number of deployed RFIP hardware devices 10 also increases. As such, these RFIP hardware devices 10 increase scalability and reduce cost.

The RFIP framework 100 is scalable and extensible because it utilizes processing software that provides a pluggable software architecture that drives the RFIP framework 100. The processing software can be either integrated into the RFIP server 120 or into the RFIP hardware device 10. Since the framework 100 is configured as a pluggable framework, components can be added by implementing the appropriate interface, such as .NET, for the desired plug-in.

As such, the framework 100 provides for three configurable components: data readers, data processors, and data publishers. In a preferred embodiment, the RFIP framework 100 supports an RFCODE™ based data reader. Further, the data reader does not necessarily have to read data from an RFID reader device, such as reader 50. The data reader may be configured to read data from another RFIP hardware device 10 in a heirarchal, distributed install.

A data processor allows the framework to process data as it is read from the RFID tag antennas. The RFIP framework 100 allows for any number of data processors to be linked together to transform, filter, and/or manipulate the data as necessary. Data processors can also provide trigger capabilities when certain events occur. The trigger capabilities could initiate tasks such as sending emails or starting other processes.

A data publisher publishes the processed data to some data sink, such as a queue, file, or database. A data publisher may also publish data to another RFIP device 10 in a hierarchal, distributed install. Moreover, data publishers work with data processors to smooth and filter RFID data so that data presented to an application layer is clean.

The RFIP database 130 stores many of the configuration options for the RFIP framework 100. The database 130 also provides a tracing and error logging repository. Further, the capabilities of the RFIP framework 100 can be extended by accessing the database 130 either through direct SQL connections or through a RFIP Data Manager Applications Programming Interface (API).

When an RFIP framework is installed, it is configured to map the network topography offered by the installation environment. The configuration can range from one computer, which controls multiple RFIP hardware devices 10, to a remote configuration, where remote computers control a subset of the RFIP hardware devices 10. In the remote configuration, the remote computers either advertise data back to a central RFIP network device or immediately place the data in a database that can be queried for use by a controlling application.

In FIG. 4, the RFIP framework 100 is installed in a basic configuration. Each RFID tag includes an antenna 110. An RFIP hardware device 10, including a RFID reader 50 and a CPU 22, reads and processes RF signals from the antennas 110. The RFIP server controls the RFIP hardware devices and publishes the RFID data to the RFIP database 130. In the basic configuration, only one server 120 controls all of the RFIP hardware devices 10. The server 120 is responsible for telling the RFIP hardware devices 10 which antenna 110 to select. Moreover, the RFIP server 120 may or may not contain an application through which users interface with the framework 100, as described above.

In FIG. 5, the framework 100 is installed in a remote configuration. The remote configuration is more complex that the basic configuration and consists of two or more basic configurations that are all controlled by one central controlling computer and/or server. Like the basic configuration, the remote configuration includes a plurality of RFID tags having antennas 110. These antennas 110 send RF signals to RFIP hardware devices 10. The hardware devices 10 are connected to remote computers 200. The remote computers 200 are connected to the server 120, which publishes the RFID data to the RFIP database 130. Alternatively, instead of the remote computers 200 passing the data to the server 120, the remote computers 200 can pass the data directly to the database 130, which is ideal for real-time processing.

The connections between the RFIP hardware devices 10 and the remote computers 200 are preferably over a TCP/IP protocol, but the connections could also be wired or wireless. Also, the database 130 can reside on a separate, dedicated database server or could be installed on the server 120.

In use, the RFIP server 120 determines which antennas 110 are selected in each remote cluster by sending a request to the remote computer 200. The remote computer then relays that the request to the RFIP hardware devices 10. As such, each remote computer 200 always knows which antennas 110 are currently selected for each RFIP hardware device 10 attached to it. Likewise, the server 120 always knows which antennas 110 are currently selected for each RFIP hardware device 10 for each remote computer 200 across the entire RFIP network 100.

The foregoing description of the present invention has been presented to illustrate the principles of the invention and not to limit the invention to the particular embodiments illustrated. It is intended that the scope of the invention be defined by all of the embodiments encompassed within the following claims and their equivalents.

We claim:

1. A system for monitoring a radio frequency identification network, comprising: a plurality of radio frequency antennas, each antenna capable of transmitting a signal representative antenna data, and a reader for reading the signals from said antennas, wherein the system only requires one reader to monitor the radio frequency identification network.

2. The system for monitoring a radio frequency identification network of claim 1, further comprising a radio frequency switch for isolating a signal from an antenna and a radio frequency switch controller for controlling said radio frequency switch wherein said reader reads signals isolated by said radio frequency switch.

3. The system for monitoring a radio frequency identification network of claim 2, wherein said radio frequency switch controller controls said radio frequency switch to isolate each antenna signal for a specific amount of time so that said reader periodically reads each signal.

4. The system for monitoring a radio frequency identification network of claim 2, further comprising software employing a real-time “time sliced” methodology to control the radio frequency switch.

5. The system for monitoring a radio frequency identification network of claim 2, further comprising a central processing unit for processing antenna signals.

6. The system for monitoring a radio frequency identification network of claim 5, further comprising a data storage device for storing antenna data.

7. The system for monitoring a radio frequency identification network of claim 6, further comprising a network connection for transmitting antenna data to a network.

8. The system for monitoring a radio frequency identification network of claim 7, wherein said network connection is a wireless connection.

9. The system for monitoring a radio frequency identification network of claim 2, further comprising a unit housing said reader, said radio frequency switch, and said radio frequency switch controller.

10. A method for monitoring a radio frequency identification network, comprising: forming a radio frequency identification network by placing plurality of radio frequency antennas on objects, each antenna capable of transmitting a signal representative antenna data, and utilizing one reader to read the antenna signals.

11. The method for monitoring a radio frequency identification network of claim 10, further comprising isolating each of the signals from said antennas for a specific amount of time so that said reader periodically reads each of the signals.

12. The method for monitoring a radio frequency identification network of claim 10, further comprising utilizing a radio frequency switch to isolate each of the signals from said antennas and utilizing a radio frequency switch controller for controlling said radio frequency switch.

13. The method for monitoring a radio frequency identification network of claim 12, wherein said radio frequency switch isolates each of the signals from said antennas for a specific amount of time so that said reader periodically reads each of the signals.

14. The method for monitoring a radio frequency identification network of claim 10, further comprising processing the signals from said antennas.

15. The method for monitoring a radio frequency identification network of claim 14, further comprising storing the signals from said antennas in a memory device.

16. The method for monitoring a radio frequency identification network of claim 15, further comprising transmitting the signals from said antennas to a network.

17. A system for managing a plurality of radio frequency identification networks, comprising:
a plurality of radio frequency identification networks, each radio frequency identification network including a plurality of radio frequency antennas, each antenna capable of transmitting a signal representative antenna data, a reader for reading the signals from said antennas, and a network connection, wherein the system only requires one reader to monitor each radio frequency identification network;
a server for controlling said plurality of radio frequency identification networks, said server interfaced said network connection of each radio frequency identification networks; and
a database for storing antenna and network data.

18. The system for managing a plurality of radio frequency identification networks of claim 17, further comprising software that provides a pluggable software architecture so that components can be added to the system.

19. A system for managing a plurality of radio frequency identification networks of claim 17, further comprising a data processor for processing antenna and network data.

20. A system for managing a plurality of radio frequency identification networks of claim 19, further comprising a data publisher for publishing data processed by said data processor.
